(19) United States
(12) Patent Application Publication
(10) Pub. No.: US 2022/0112069 A1
(43) Pub. Date: Apr. 14, 2022

(54) Touchless Dispense System With Safety Feature

(71) Applicant: Wilbur Curtis Co., Inc., Montebello, CA (US)

(72) Inventors: Jason Abrego, Pico Rivera, CA (US); Harold Edward Reitberger, Westminster, CA (US); Winfred Ivan Dy See, Diamond Bar, CA (US)

(73) Assignee: Wilbur Curtis Co., Inc., Montebello, CA (US)

(21) Appl. No.: 17/070,359

(22) Filed: Oct. 14, 2020

(51) Int. Cl. B67D 1/08; G01V 8/20; B67D 1/12; A47J 31/46; A47J 31/52

(52) U.S. Cl. CPC B67D 1/0888; G01V 8/20; A47J 31/525; A47J 31/461; A47J 31/467; B67D 1/1277

(57) ABSTRACT

A liquid dispensing system includes a reservoir, a spout above a receiving space, and a fluid channel. The fluid channel is configured to permit flow of liquid from the reservoir through the spout upon detection of contemporaneous presence of a first object in a user space other than the receiving space and presence of a second object within the receiving space. The system also includes a first sensor configured to detect the presence of the first object in the user space, and a second sensor discrete from the first sensor and configured to detect the presence of the second object in the receiving space.

### FIELD OF THE INVENTION

The present invention relates generally to a dispensing system and more particularly to a liquid or beverage dispensing system.

### BACKGROUND

Simple liquid dispensers, such as beverage dispensers, have a liquid source connected to a spout fitted with a valve. Where the valve is mechanical, the valve is connected to a lever or button that a user may move or press to move the valve such that the liquid may exit the spout. More advanced dispensers have control boards that control a motor to move the valve in response to user inputs, such as button presses or selections through a touch screen.

Such known dispensers are susceptible of creating spills. For example, there is nothing to stop the above described sensors from dispensing liquid in the absence of a vessel to catch the liquid in response to erroneous actions upon the lever, button, or touch screen. Further, dispensers with electronically controlled valves may have no way for the user to halt dispensation of liquid if, for example, a placed vessel is filled or displaced. Such spills can create messes and, particularly if the liquid is a hot beverage such as freshly brewed coffee, hazards.

Such known dispensers also pose hygienic liabilities if accessed by multiple users. Residue and contaminants accumulate with each manual activation of the lever, button, or touch screen and will be picked up by later users. If the dispensed liquid is a beverage, an unwary user is likely to transfer the residue and contaminants to the vessel after the liquid is dispensed, then to bring the vessel to his or her face to consume the beverage. Such hygienic liabilities are undesirable in normal circumstances and quite hazardous during an epidemic.

### BRIEF SUMMARY

According to an aspect of the disclosure, a dispensing system may allow dispensing of a liquid without physical contact or interaction with any element of the dispensing system by a user. The dispensing system may be configured to dispense liquid without mechanical actuation of any part of the dispensing system or contact sensing, with the possible exception of mechanical or contact sensing based detection of a vessel placed to receive the liquid. The dispensing system may monitor a user space other than a receiving space for the vessel, and may prevent dispensation of the liquid into the receiving space unless a presence of an object is detected in the user space. The dispensing system may also be configured to monitor the receiving space and prevent dispensation of the liquid into the receiving space unless a presence of an object is detected in the receiving space. Thus, the dispensing system may be configured to dispense liquid only during the detection of the presence of an object in the user space contemporaneous with the detection of the presence of an object in the receiving space. The user space may be monitored for the presence of an object by a contactless first sensor and the receiving space may be monitored for the presence of an object by a second sensor discrete from the first sensor. The system may further be configured such that either the first sensor or second sensor only receives power if the other sensor detects the presence of an object in its respective monitored space.

The dispensing system may include a valve, the first sensor, the second sensor, and a control board. The valve may be positioned to selectively open and close a spout of the dispenser positioned to direct liquid into the receiving space. The control board may be configured to power the first sensor and the second sensor and to interpret signals received from the first sensor and the second sensor. The control board may be configured to keep the valve closed except when signals from the first sensor and the second sensor indicate contemporaneous presence of an object in the user space and an object in the receiving space. The system or control board may further be configured to keep the valve closed unless signals from the first sensor and second sensor indicate that the user space and the receiving space both become occupied within a predefined window of time. For example, if the user space remains empty for a predetermined time, such as 5 seconds, after an object is detected as entering the receiving space, the system or control board may be configured to keep the valve closed at least until either or both of the user space and the receiving space is detected to be unoccupied again. Similarly, if the receiving space remains empty for the predetermined time after an object is detected as entering the user space, the system or control board may be configured to keep the valve closed at least until either or both of the user space and the receiving space is detected to be unoccupied again.

According to another aspect, a liquid dispensing system may comprise a reservoir, a spout above a receiving space, and a fluid channel. The fluid channel may be configured to permit flow of liquid from the reservoir through the spout upon detection of contemporaneous presence of a first object in a user space other than the receiving space and of a second object within the receiving space. The system may further comprise a contactless first sensor configured to detect the presence of the first object in the user space and a second sensor discrete from the first sensor and configured to detect the presence of the second object in the receiving space.

In some arrangements, the system may further comprise a valve within the spout fluid channel for selectively allowing or stopping flow of liquid into the receiving space. The system may further comprise a control board configured to interpret electrical signals from the first sensor and the second sensor and generate a control signal for controlling the valve based on the electrical signals.

In some arrangements, the first sensor may be configured to remain inactive unless the second sensor detects the presence of the second object in the receiving space or the second sensor is configured to remain inactive unless the first sensor detects the presence of the first object in the user space.

In some arrangements, the system may comprise a brewer configured to produce a brewed liquid by passing a solvent through a substrate and to direct the brewed liquid into the reservoir.

In some arrangements, the first sensor may be mounted to any of the spout, the reservoir, and the brewer, and the second sensor may be mounted to any of the spout, the reservoir, and the brewer.

In some arrangements, either or both of the first sensor and the second sensor may include any one of a collision sensor, distance sensor, ultrasonic sensor, microphone, optical sensor, thermal sensor, motion sensor, humidity sensor, pyroelectric infrared sensor, accelerometer, and radio frequency sensor.

In some arrangements, the second sensor may be a contactless sensor.

In some arrangements, the system may comprise a first light emitter positioned to emit light into the user space and a second light emitter positioned to emit light into the receiving space. The first sensor may be a photosensor positioned to detect light from the first light emitter reflected from an object in the user space and the second sensor may be a photosensor positioned to detect light from the second light emitter reflected from an object in the receiving space.

In some arrangements, the first light emitter and second light emitter may both include light emitting diodes.

In some arrangements, the system may comprise a first light emitter configured to emit light into the user space and the first sensor may be a photodiode photosensor positioned to detect light from the first light emitter reflected from an object in the user space.

In some arrangements, the system may comprise a solenoid valve within the spout for selectively allowing or stopping flow of liquid into the receiving space. The system may also comprise a first control board configured to monitor the first sensor and a discrete second sensor and to govern the solenoid valve to permit flow of liquid out of the spout only during simultaneous detection of the first object in the space above the spout by the first sensor and the second object within the receiving space by the second sensor.

In some arrangements, the control board may receive power through a discrete second control board.

In some arrangements, the system may comprise a brewer configured to fill the reservoir with a brewed liquid.

In some arrangements, the brewed liquid may be coffee.

In some arrangements, the system may comprise a discrete second control board configured to control electronics associated with the reservoir and supply the first control board with power.

In some arrangements, the user space may be above the spout.

In another aspect a valve control circuit for controlling a valve positioned in a liquid dispensing channel of the liquid dispensing system may be configured to receive, from a contactless first sensor, a first sensor signal indicating a presence of a user of the liquid dispensing system, and to receive, from a second sensor discrete from the first sensor, a second sensor signal indicating a presence of a vessel positioned in a receiving space of the liquid dispensing system to receive a dispensed liquid. In response to receiving both the first sensor signal and the second sensor signal, the valve control circuit may transmit a control signal to open the valve.

In another aspect, a liquid control system may include the valve control circuit, and a main control circuit for controlling the liquid dispensing system. The valve control circuit may be configured to receive power from the main control circuit and to distribute the received power to the first sensor, the second sensor, and the valve.

In some arrangements, the valve control circuit may be either configured to supply power to the first sensor only while receiving the second sensor signal or to supply power to the second sensor only while receiving the first sensor signal.

In some arrangements, the main control circuit may be configured to control, directly or through a brew control circuit discrete from the valve control circuit, either or both of brewing a brewed liquid and heating the brewed liquid in a reservoir in fluid communication with the valve.

### BRIEF DESCRIPTION OF THE DRAWINGS

FIG. 1 is an isometric view of an example liquid dispenser in accordance with the present disclosure while in use.

FIG. 2 is an exploded view of a spout assembly of the liquid dispenser of FIG. 1.

FIG. 3A is a schematic representation of sensor modules of the liquid dispenser of FIG. 1.

FIG. 3B is a schematic representation of electronic aspects of the liquid dispenser of FIG. 1.

FIG. 4A is an isometric view of a first example arrangement of a liquid dispenser of FIG. 1.

FIG. 4B is an isometric view of a second example arrangement of the liquid dispenser of the FIG. 1.

### DETAILED DESCRIPTION

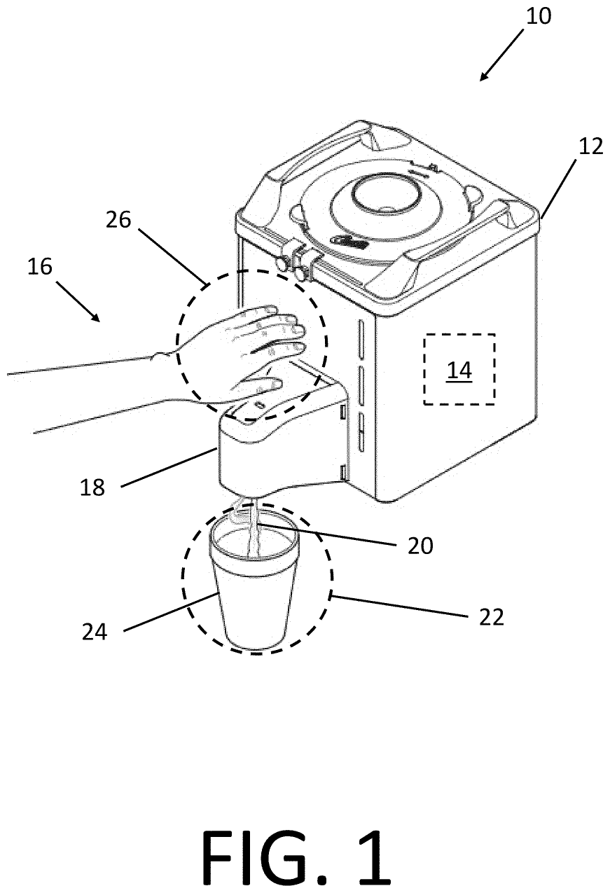

A dispenser 10 according to an aspect of the present disclosure is illustrated in FIG. 1. In the illustrated example, the beverage dispenser 10 is a coffee dispenser, but the teachings of this disclosure may be applied to a dispensing system for any substance or commodity. Other applications include dispensation of cold beverages, non-beverage fluids, and solid bulk goods such as grains and coffee beans. Further, the dispenser 10 of the illustrated arrangement includes a tank 12 housing a reservoir 14 that contains the coffee, but the dispenser 10 in other applications may lack a dedicated tank and reservoir, such as in the case of dispensing water from a building's tap water system.

The dispenser 10 of FIG. 1 is in use by a user 16, whose hand extends over an outlet assembly 18. The outlet assembly 18 dispenses coffee 20 into a receiving space 22 below the outlet assembly 18. A vessel 24, being a cup in the illustrated arrangement, is disposed within the receiving space 22 to receive the dispensed coffee 20.

The dispenser 10 is configured to only dispense coffee 20 from the reservoir 14 while an object, such as the user's 16 hand, is present in the user space 26. In the illustrated arrangement, only one user space exists 26, and the user space 26 is above the outlet assembly 18. The user 16 may therefore commence dispensation of the coffee 20 by extending his or her hand over the outlet assembly 18, and may halt dispensation by withdrawing his or her hand from the from over the outlet assembly 18. In other arrangements, the user space 26 is located elsewhere. The user space 26 may be located anywhere relative to the outlet assembly 18, or any other feature of the dispenser 10, that would be convenient for a user to access in a given application. Moreover, multiple discrete user spaces 26 may be defined corresponding to different options among a group of available substances for dispensation. For example, in some arrangements, the dispenser 10 is provided with a second user space (not shown), and may dispense water instead of coffee if the user 16 extends a hand into the second user space. In further examples, the dispenser 10 may be configured to execute a predefined dispensation option based on how long an object is detected in the user space 26, or depending on hand gestures or repetition of actions detected within the user space 26. For example, the dispenser 10 may tally a number of times a hand passes through the user space 26 while a vessel 24 is within the receiving space 22, and then dispense a total amount of coffee that is a function of the number of passes.

As illustrated, the dispenser 10 contactlessly detects the presence of the user's 16 hand, or another object, in the user space 26. That is, the dispenser 10 detects the presence of the user's 16 hand without the hand touching any part of the dispenser 10.

The dispenser 10 is also configured to dispense coffee 20 only while an object, such as the vessel 24, is present in the receiving space 22. The dispenser 10 will therefore dispense coffee 20 only during contemporaneous presence of an object in the receiving space 22 and presence of an object in the user space 26. The dispenser 10 is thus prevented from dispensing coffee 20 into the receiving space 22 with nothing therein to catch the coffee 20. The risk of spills upon false detections or inadvertent passage of objects through the user space 26 is thereby reduced.

In various arrangements, the dispenser 10 may be configured to keep a valve 30 (detailed below) open for a predetermined amount of time upon detection of contemporaneous presence of objects in the user space 26 and receiving space 22, or to have the valve 30 open when, and only when, contemporaneous presence of objects in the user space 26 and receiving space 22 is detected. In another example, the dispenser 10 may be configured to open the valve 30 upon detection of contemporaneous presence of objects in the user space 26 and receiving space 22, and to close the valve 30 upon the sooner of the passage of a predetermined window of time or detection of one or both of the user space 26 and receiving space 22 becoming unoccupied.

To further reduce the risk of unintended dispensation, the dispenser 10 may be configured to only begin dispensing liquid if it detects both spaces 22, 26 becoming occupied within a predetermined window of time. The predetermined window of time may be of any duration, but specifically contemplated examples include exactly or about all integer numbers of seconds between 1 and 60, inclusive, such as exactly or about 5 seconds, with “about” meaning within 0.5 seconds. For example, the predetermined window of time may begin whenever sensor signals indicate that either of the receiving space 22 and the user space 26 changes from being unoccupied to occupied, and the dispenser 10 may only begin to dispense liquid if the other of the receiving space 22 and the user space 26 is detected to change from being unoccupied to occupied before the end of the predetermined window of time.

In the illustrated arrangement, the dispenser 10 also contactlessly detects the presence of the vessel 24 within the receiving space 22. However, in other arrangements, a contact sensor, such as a lever, pressure plate, button, or any other mechanical switch, an electromagnetic touch sensor, or any other contact sensor that may register the vessel 24 itself is used to detect the presence of the vessel 24 within the receiving space 22. The user 16 therefore retrieves coffee 20 by placing the vessel 24 into the receiving space 22, the presence of which will be detected via any suitable sensor, and by extending a hand or any other object into the user space 26. The user 16 is thus able to retrieve coffee 20 from the dispenser 10 without touching any part of the dispenser 10, and without causing any other object to contact the dispenser 10, with the possible exception of the vessel 24 in certain arrangements.

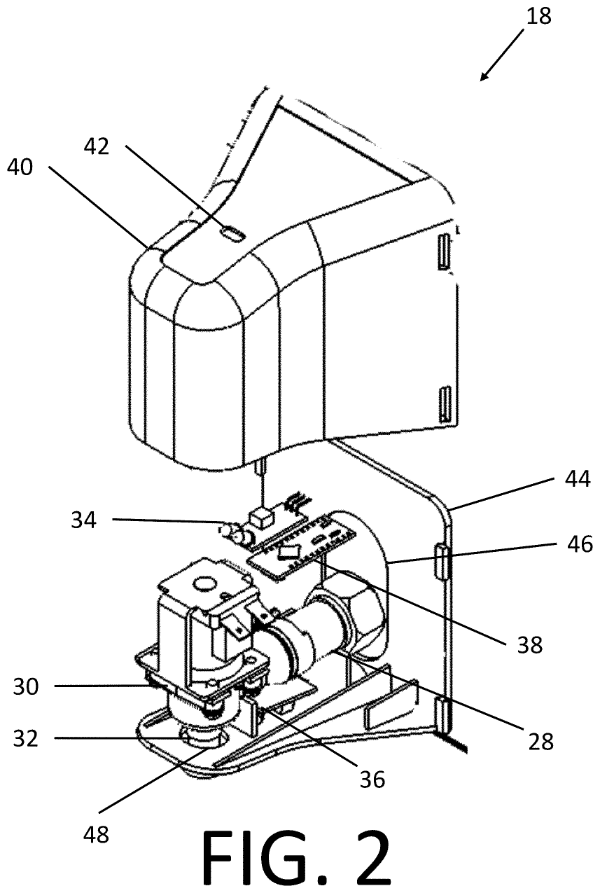

FIG. 2 illustrates components of the outlet assembly 18. Within the outlet assembly 18, a tube 28 in fluid communication with the source of fluid, which may be the reservoir 14, for example, in the illustrated arrangement, connects to a valve 30. The valve 30 of the illustrated arrangement is a solenoid valve, but in other arrangements the valve may be another type of valve, such as a plate with an electromagnet that swings to obstruct dispensation of the liquid when activated. A nozzle 32 extends from the valve 30 to direct the coffee 20 toward the receiving space 22.

In the illustrated arrangement, the tube 28, valve 30, and nozzle 32 collectively define a spout of the outlet assembly 18. In other arrangements, the spout lacks either or both of the nozzle 32 or the tube 28. In arrangements lacking the nozzle 32 liquid may flow directly from the valve to the receiving space 22, and in arrangements lacking the tube 28, the valve 30 may be disposed directly against the reservoir 14 or other fluid source.

In the illustrated arrangement, with only one user space 26, the spout is solitary and the valve 30 simply opens or closes. In some alternative arrangements having multiple user spaces 26 corresponding to multiple dispensing options as discussed above, a separate spout is provided for each dispensing option. In other such arrangements, the spout is solitary, but multiple tubes 28 each corresponding to a fluid source associated with a different user space 26 and dispensing option flow into respective valves 30 upstream from a shared nozzle 32, with each valve 30 being configured to open only when the presence of an object is detected within the corresponding user space 26. In yet other such arrangements, the spout is solitary and includes multiple tubes 28 from different fluid sources connected to a single valve 30 and nozzle 32, and the valve 30 selectively opens or closes communication between a certain tube 28 or tubes 28 and the nozzle 32 according to which of multiple user spaces 26 an object is found to be present in. In still other such arrangements, the spout is solitary, and the sole valve 30 opens to a varying degree depending on which of multiple user spaces 26 an object is found to be present in.

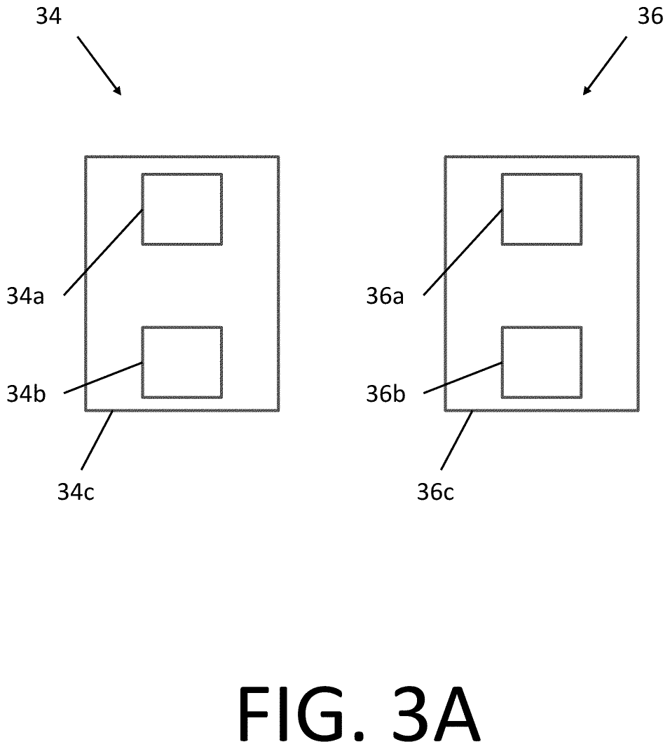

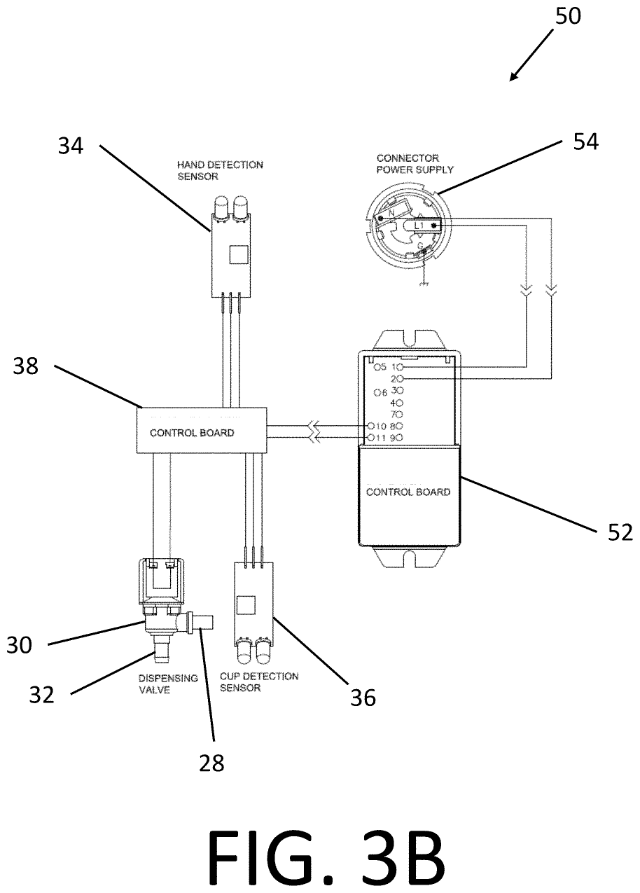

Turning to FIG. 3A, with continued reference to FIG. 2, a first contactless sensor module 34 including a first contactless sensor 34a is disposed over the tube 28 to monitor the user space 26 for the presence of an object. Here, a contactless sensor refers to any sensor that can detect the presence of an object in a space without physical contact between the object and another solid element. Contactless sensors therefore include, for example, optical, thermal, electromagnetic, and ultrasonic sensors and near field communication and radio frequency identification systems. In the illustrated example, the first sensor module 34 also includes a first emitter 34b capable of creating phenomena detectable by the first sensor 34a. Thus, the first sensor module 34 may detect a presence of an object in a space by creating phenomena with the first emitter 34b and detecting variations in the phenomena with the first sensor 34a.

A second sensor module 36 including a second sensor 36a is similarly disposed below the tube 28 to monitor the receiving space 22 for the presence of an object. In the illustrated arrangement, the second sensor is also contactless, though as noted above the second sensor may be a contact sensor in some alternative arrangements. In the illustrated example, the second sensor module 36 also includes a second emitter 36b capable of creating phenomena detectable by the first sensor 36a. Thus, the second sensor module 36 may detect a presence of an object in a space by creating phenomena with the second emitter 36b and detecting variations in the phenomena with the second sensor 36a.

One or both of the first sensor module 34 and second sensor module 36 may include a chip onto which its respective sensor is disposed, such as the first chip 34c and second chip 36c, respectively, of the illustrated example. FIG. 3A represents the sensor modules 34, 36 schematically, so the shape and form of the chips 34c, 36c and the proportion and location of objects on the chips such as the sensors 34a, 36a and emitters 34b, 36b may differ from what is shown.

Also, in some examples, one or both of the first sensor 34a and second sensor 36a may be infrared photosensors. For those sensors including a photosensor, the emitter 34b, 36b may also include or be an infrared light emitting diode (LED). The LED may be directed toward the respective sensing area of its corresponding photosensor (e.g., the user space 26 for the first sensor module 34, and the receiving space 22 for the second sensor module 36). In operation, the sensor modules 34, 36 may be configured to shine infrared light from the infrared LED into the sensing area, whereby the light shine may reflect off an object present in the sensing area (e.g., a hand in the user space 26, or a vessel in the receiving space 22). The corresponding photosensors in the sensor modules 34, 36 may further be positioned so as to receive the reflected infrared light.

In the exemplary arrangement of FIG. 2, both the first sensor module 34 and the second sensor module 36, respectively, include infrared photosensors and LEDs. In various alternative arrangements, either or both of the first sensor and second sensor may be any one or any combination of the following sensors, which include contact sensors and contactless sensors: a collision sensor, distance sensor, ultrasonic sensor, microphone, optical sensor, thermal sensor, motion sensor, humidity sensor, pyroelectric infrared sensor, accelerometer, and radio frequency sensor.

In some other arrangements, the infrared photosensor 34a, 36a of sensor module 34, 36, respectively, may be located opposite of the corresponding LED 34b, 36b, respectively, or may be positioned to receive light from a reflective surface positioned opposite of the corresponding LED, such that light emitted from the LED to the photosensor travels along a path that crosses the sensing area. In such an arrangement, presence of an object in the sensing area may block the path from the LED to the corresponding photosensor, and would be indicated instead by detection of occlusion of the infrared light from across the space. The same concept may be applied with LEDs for other spectra and other types of sensors in various other arrangements, wherein in some arrangements sensor module 34, 36 includes a sensor 34a, 36a, respectively, paired with an immediately adjacent emitter 34b, 36b, respectively, the reflected emission of which indicates a present object, and in some other arrangements sensor module 34, 36 includes a sensor 34a, 36a, respectively, paired with an emitter 34b, 36b, respectively, across a corresponding monitored space or directed at a reflective surface, an occlusion of the emission of which indicates a present object.

The first sensor module 34 and second sensor module 36 are both in communication with an outlet control board 38. The control board any include one or more conventional processors, including but not limited to commercially available CPUs. Alternatively, the processor may be a dedicated device such as an ASIC or other hardware-based processor.

The outlet control board 38 is configured to interpret signals from the first sensor module 34 and second sensor module 36 and to govern the valve 30 to remain closed unless both signals indicate the presence of the object in their respective space. Thus configured, the outlet control board 38 will send a control signal to the valve 30 to cause the valve 30 to open or close as appropriate based on the detected presences of objects in the user space 26 and receiving space 22. Through this relationship between the valve 30 and the control board 38, the spout provided by the tube 28, valve 30, and nozzle 32 is configured to dispense coffee 20 into the receiving space 22 only when the presence of an object is detected in both the user space 26 and the receiving space 22. The outlet control board 38 may be configured with a logic that discerns the nature of an object present in the receiving space 22. For example, the outlet control board 38 may be able to determine if an object present in the receiving space 22 is an unsuitable object, such as a human hand, or a suitable object, such as a vessel 24, and to only dispense liquid if the object in the receiving space 22 is suitable. The second sensor module 36 may provide the outlet control board 38 with the information used to make such a determination, and may include sensors for such purpose in addition to those described above.

The outlet control board 38 also supplies power to the first sensor module 34 and second sensor module 36. In some arrangements, as a power saving measure, the outlet control board 38 may be configured to continuously power only one of the first sensor module 34 and the second sensor module 36, and to avoid powering the other of the first sensor module 34 and the second sensor module 36 unless the outlet control board 38 receives a signal from the continuously powered sensor module indicating that presence of an object is detected. In some such arrangements, this power saving measure is achieved by powering the second sensor module 36 only when the presence of an object in the user space 26 is detected through the first sensor module 34, which is powered without regard to signals from the second sensor module 36. In other arrangements, this power saving measure is achieved by powering the first sensor module 34 only when the presence of an object in the receiving space 22 is detected through the second sensor module 36, which is powered without regard to signals from the first sensor module 34. Either sensor module 34, 36 may only be powered for a predetermined amount of time after the other sensor module 34, 36 begins to detect an object within the corresponding space 22, 26. The predetermined amount of time may be any amount, but specifically contemplated examples include exactly or about all integer numbers of seconds between 1 and 60, inclusive, such as exactly or about 5 seconds, with “about” meaning within 0.5 seconds.

Because the coffee 20 is only dispensed when an object is detected in both the receiving space 22 and the user space 26, power to either sensor module 34, 36 may be made to depend on signals from the other without altering the steps for obtaining coffee 20 from the dispenser 10. Thus, if either sensor module 34, 36 consumes more power than the other, the outlet control board 38 may be configured to continuously power the sensor module 34, 36 that consumes less power, and to avoid powering the sensor module 34, 36 that consumes more power until the other sensor module 34, 36 detects the presence of an object in its corresponding monitored space 22, 26. For instance, in certain alternative arrangements having multiple user spaces 26, in which multiple first sensor modules are provided and each first sensor module is configured to monitor a respective user space 26, more power may be saved by configuring the control board 38 to continuously power the second sensor module 36 and to avoid powering any of the first sensor modules until the presence of an object in the receiving space 22 is detected.

The outlet assembly 18 of the illustrated arrangement includes an upper shell 40 and a lower shell 44 that, together, mostly enclose the spout, sensor modules 34, 36, and outlet control board 38. The upper shell 40 includes an aperture 42 through which the first sensor module 34 monitors the user space 26. Though not visible from the perspective of FIG. 2, the lower shell 44 includes a similar aperture through which the second sensor module 36 monitors the receiving space 22. The lower shell 44 further includes an entrance 46 through which the tube 28 extends to connect to the reservoir 14 and an exit 48 through which the nozzle 32 protrudes to guide dispensed coffee 20 to the receiving space 22. The upper shell 40 and lower shell 44 both protect the other contents of the outlet assembly 18, but otherwise serve primarily aesthetic purposes. As such, the upper shell 40 and lower shell 44 are variously joined, omitted jointly or individually, or presented with different appearances in other arrangements.

Though both sensor modules 34, 36 of the illustrated arrangement are shown within the outlet assembly 18, alternative arrangements place the sensor modules 34, 36 elsewhere. Each sensor module 34, 36 may be mounted to any part of the dispenser 10, or any part of a dispensing system into which the dispenser 10 is incorporated, suitable for monitoring the corresponding space 22, 26. In some alternatives, either the first sensor module 34 or second sensor module 36 is mounted to the tank 12 outside of the outlet assembly 18, while the other sensor module 34 or 36 is mounted within the outlet assembly 18. In other alternatives, the first sensor module 34 and second sensor module 36 are both mounted to the tank 12 outside of the outlet assembly 18.

Control electronics 50 of the dispenser 10 are schematically illustrated in FIG. 3B. Though not necessarily electronics themselves, the tube 28 and nozzle 32 are shown in FIG. 3 for illustrative purposes. The control electronics 50 include the valve 30, the first sensor module 34, the second sensor module 36, and the outlet control board 38 described above with regard to the outlet assembly 18, with the first sensor module 34 and second sensor module 36 each being connected to the outlet control board 38 by two power wires and a signal wire.

The electronics 50 shown in FIG. 3B further include a hub control board 52. The hub control board may include one or more processors, which may be the same or different from the processors included in the outlet control board 38. The hub control board 52 is connected to a power supply through a power supply connector 54 and transfers power to the outlet control board 18. Though not illustrated in FIG. 3B, other electronics of the dispenser may be connected to the hub control board for power and governance. For example, in some arrangements, the hub control board 52 may control any one or combination of a heater within the tank 12 for maintaining coffee 20 within the reservoir 14 at an intended serving temperature, a heater for heating water in a water tank before the water is dispensed to brew the coffee, one or more valves controlling the release of water from the water tank, and so on.

In some arrangements, the dispenser 10 is a complete dispensing system unto itself. In other arrangements, a dispensing system includes other elements in addition to the dispenser 10.

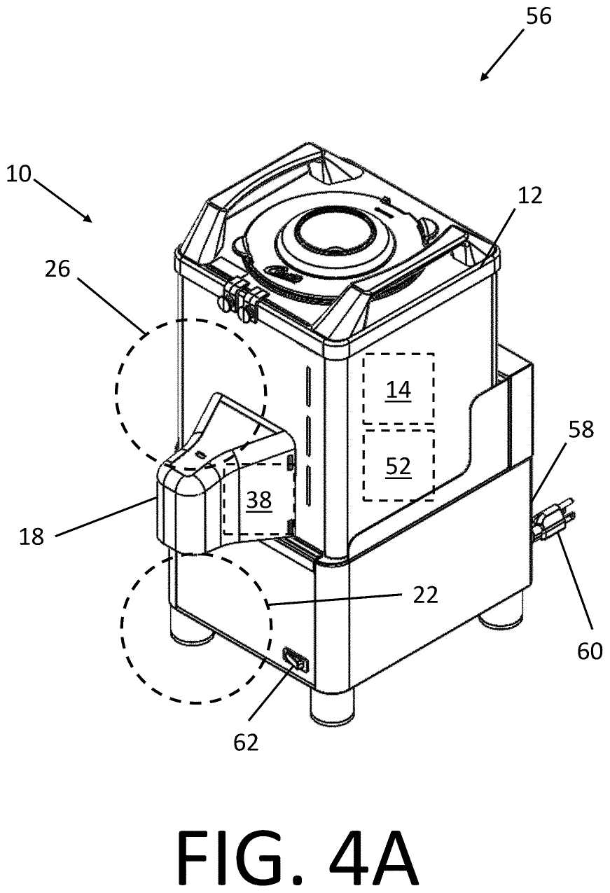

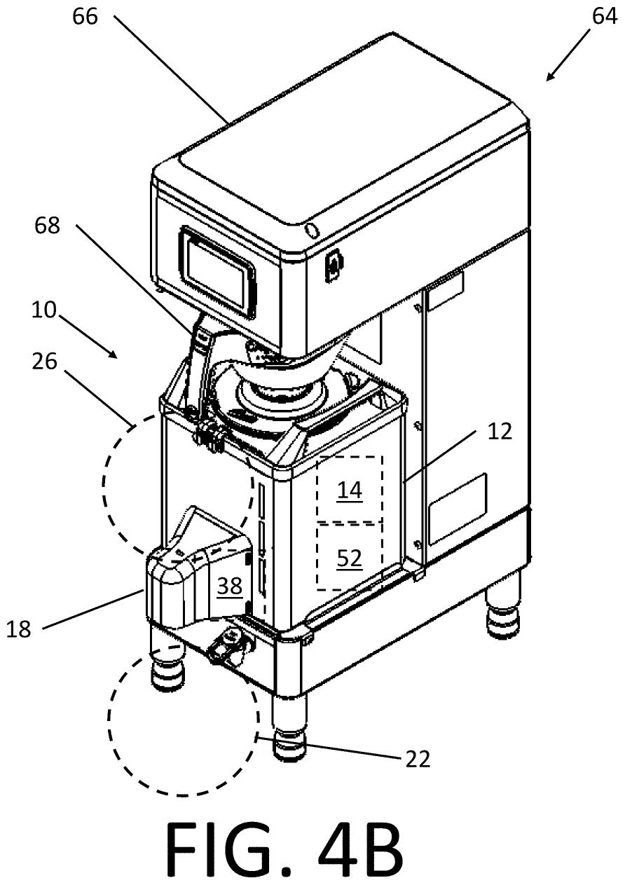

A coffee dispensing system 56 according to an arrangement including a powered base 58 is illustrated in FIG. 4A. The powered base 58 as illustrated has a plug 60 for connection to a power source and an on/off switch 62 for activating and deactivating the system 56. The powered base 58 operatively connects to the dispenser 10 to transfer power from the plug to the hub control board 52. Some arrangements of the powered base 58 include a heater to maintain temperature of coffee 20 in the reservoir 14 if no heater is included in the tank 12.

In alternative arrangements, the hub control board 52 is disposed within the powered base 58 instead of the tank 52 as illustrated. In such arrangements, the hub control board 52 may control a heater if present within the powered base 58 and is in electronic communication with the outlet control board 38 through an interface between the dispenser 10 and the powered base 58. In further alternative arrangements, either or both of the first sensor and second sensor, with or without the rest of the corresponding sensor module 34, 36, is mounted to the powered base 58 instead of the dispenser 10.

A coffee brewing and dispensing system 64 according to an arrangement including a brewer 66 is illustrated in FIG. 4B. Much like the powered base 58, the brewer 66 according to various arrangements has any one or any combination of a heater for the reservoir 14, a plug, and an on/off switch, and in further arrangements houses or provides a mount for any one or any combination of the hub control board 52, the first sensor 34a, the first sensor module 34, the second sensor 36a, and the second sensor module 36.

The brewer also includes features for producing a brewed liquid, in this case coffee, and depositing the brewed liquid into the reservoir 14. To produce the brewed liquid, the brewer passes a solvent through a substrate including compounds soluble into the solvent. In the illustrated example, the solvent is hot water, and the substrate is coffee grounds stored in a basket 68. The brewer 66 includes a heater, which may or may not be the heater used to maintain temperature of coffee 20 in the reservoir 14, to heat the water before it is dripped into the basket 68. The brewer 66 also includes a spigot near the receiving space 22 to dispense hot water directly. In some arrangements the hub control board 52 controls the heater of the brewer 66 and any other electronics involved in brewing the coffee 20, whether the hub control board 52 is within the brewer 66 or is merely in electronic communication with the brewer 66 through an interface between the dispenser 10 and the brewer 66. In certain other arrangements, the brewer 66 contains a discrete brewer control board that governs the heater of the brewer 66 and any other electronics involved in brewing the coffee 20.

The above example arrangements are generally described as including two separate control boards. However, it should be recognized that the underlying concepts of the present disclosure are similarly applicable to other example arrangements in which the functions of the separate control boards are combined in a single control board.

In a similar vein, the above example arrangements generally describe the main control board as being assigned most functions of the system except for controlling a dispenser valve, and the satellite control board being assigned control of the dispenser valve. However, it should be recognized that the underlying concepts of the present disclosure are similarly applicable to other example arrangements in which the separate control boards are assigned different respective functions, such as a main board that controls only heaters and a satellite board that controls only valves. Alternatively, some example arrangements may assign control of one sensor module, such as the first sensor module, to the main circuit board, while control of the other sensor module, such as the second sensor module, is assigned to the satellite board. Such an arrangement may be beneficial for systems in which a user may select from different options released from a single valve, and further for systems in which electronics other that the dispenser valve may be activate based on a contactless user input. It should be noted that such arrangements may still have the same power-saving benefits as described herein. For instance, the main control board may be configured to relay a control instruction to the satellite board to activate the second sensor module in response to receiving a detection signal from the first sensor module.

Additionally, the above example arrangements generally describe a contactless sensor arrangement for controlling a dispenser valve for dispensing already brewed coffee. However, it should be recognized that the underlying concepts of the present disclosure are similarly applicable to other valves of the same or similar systems. For instance, the sensor arrangement may be used to control a valve for releasing water from a water tank into a heater, or for releasing hot water from a heated tank into a brewing receptacle. Such arrangements may be beneficial for systems initiating a coffee brewing process upon contactless user command. In some examples, water tank valves and dispenser valves may both be controlled by dual contactless sensor modules.

Some of the above example arrangements generally describe systems wherein a valve 30, configured to be open only if the contemporaneous presence of objects in two locations is detected, is disposed between a reservoir 14 of ready-to-drink beverage and a nozzle 32, the nozzle 32 being the point where the beverage exits the system 10. In some alternative arrangements, the system is instead or in addition configured to brew the beverage, such as coffee 20, upon the detection of the contemporaneous presence of objects in two locations. In such arrangements, a brew valve, instead of or in addition to a valve 30 directly upstream of the nozzle 32, is disposed between a solvent reservoir, such a reservoir of hot water, and a substrate, such as coffee grounds. The brew valve may be configured to open and close in response to signals from sensors according to any of the examples described above with regard to the valve 30. Systems according to such arrangements will thus brew and dispense coffee while contemporaneous presence of objects in two predefined spaces is detected, and will cease at least the brewing of the coffee when contemporaneous presence of objects in the two predefined spaces is not detected.

Systems according to certain alternative examples may employ the brew valve and solvent reservoir in a single-serve brew routine. The single-serve brew routine is a series of steps programmed into any of the above described control boards for on-demand preparation of a predefined quantity of brewed beverage. Such systems may open the brew valve to begin a single-serve brew routine upon detection of contemporaneous presence of objects in the two predetermined spaces. In some arrangements, if contemporaneous presence of the objects in the two predetermined spaces is detected to cease before completion of the single-serve brew routine, the brew valve may close to pause the single-serve brew routine until the contemporaneous presence is detected again. In other arrangements having a valve 30 directly upstream of a nozzle 32, if contemporaneous presence of the objects in the two predetermined spaces is detected to cease before completion of the single-serve brew routine, the valve 30 closes and the single-serve brew routine is finished by continuing to brew the beverage until a complete serving is brewed. Some portion of the complete serving is then retained behind the valve 30 until the contemporaneous presence of objects in the two predetermined spaces is detected again.

Some systems configured with a single-serve brew routine are also configured to accept brew substrates in discrete capsules, each capsule containing a single serving's worth of substrate. Single-serve brew routines may therefore include actuation of mechanisms within the system to cycle between spent and fresh capsules, prompting a user to supply a fresh capsule or remove a spent capsule, or any combination thereof. In yet further examples not using single-serve capsules, the system may otherwise cycle spent and fresh substrate or prompt a user to supply fresh substrate or remove spent substrate.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A liquid dispensing system comprising:
a reservoir;
a spout disposed above a receiving space and in fluid communication with the reservoir;
a fluid channel configured to permit flow of liquid from the reservoir through the spout upon detection of contemporaneous presence of a first object in a user space other than the receiving space and of a second object within the receiving space;
a first sensor configured to detect the presence of the first object in the user space; and
a second sensor discrete from the first sensor and configured to detect the presence of the second object in the receiving space.

2. The system of claim 1, further comprising:
a valve within the fluid channel for selectively allowing or stopping flow of liquid into the receiving space; and
a control board configured to interpret electrical signals from the first sensor and the second sensor and to generate a control signal for controlling the valve based on the electrical signals.

3. The system of claim 1, wherein the first sensor is configured to remain inactive unless the second sensor detects the presence of the second object in the receiving space or the second sensor is configured to remain inactive unless the first sensor detects the presence of the first object in the user space.

4. The system of claim 1, further comprising
a brewer configured to produce a brewed liquid by passing a solvent through a substrate and to direct the brewed liquid into the reservoir.

5. The system of claim 4, wherein the first sensor is mounted to any of the spout, the reservoir, and the brewer, and the second sensor is mounted to any of the spout, the reservoir, and the brewer.

6. The system of claim 1, wherein either or both of the first sensor and the second sensor include any one of a collision sensor, distance sensor, ultrasonic sensor, microphone, optical sensor, thermal sensor, motion sensor, humidity sensor, pyroelectric infrared sensor, accelerometer, and radio frequency sensor.

7. The system of claim 1, wherein at least one of the first sensor and the second sensor is a contactless sensor.

8. The system of claim 7, further comprising a first light emitter positioned to emit light into the user space and a second light emitter positioned to emit light into the receiving space, and
wherein the first sensor is a photosensor positioned to detect light from the first light emitter reflected from an object in the user space and the second sensor is a photosensor positioned to detect light from the second light emitter reflected from an object in the receiving space.

9. The system of claim 8, wherein the first light emitter and second light emitter both include light emitting diodes.

10. The system of claim 1, further comprising a first light emitter configured to emit light into the user space and wherein the first sensor is a photosensor positioned to detect light from the first light emitter reflected from an object in the user space.

11. The system of claim 1, further comprising:
a solenoid valve within the spout for selectively allowing or stopping flow of liquid into the receiving space; and
a first control board configured to monitor the first sensor and the second sensor and to govern the solenoid valve to permit flow of liquid out of the spout only during simultaneous detection of the first object in the space above the spout by the first sensor and the second object within the receiving space by the second sensor.

12. The system of claim 11, wherein the first control board is configured to receive power through a discrete second control board.

13. The system of claim 11, further comprising:
a brewer configured to fill the reservoir with a brewed liquid.

14. The system of claim 13, wherein the brewed liquid is coffee.

15. The system of claim 13, further comprising a discrete second control board configured to control electronics associated with the reservoir and supply the first control board with power.

16. The system of claim 1, wherein the user space is above the spout.

17. A valve control circuit for controlling a valve positioned in the liquid dispensing channel of the liquid dispensing system of claim 1, the control circuit comprising one or more processing devices configured to:
receive, from a first sensor, a first sensor signal indicating a presence of a user of the liquid dispensing system;
receive, from a second sensor discrete from the first sensor, a second sensor signal indicating a presence of a vessel positioned in a receiving space of the liquid dispensing system to receive a dispensed liquid; and
in response to receiving both the first sensor signal and the second sensor signal, transmitting a control signal to open the valve.

18. A liquid control system, comprising:
the valve control circuit of claim 17; and
a main control circuit for controlling the liquid dispensing system;
wherein the valve control circuit is configured to receive power from the main control circuit and to distribute the received power to the first sensor, the second sensor, and the valve.

19. The liquid control system of claim 18, wherein the valve control circuit is either configured to supply power to the first sensor only while receiving the second sensor signal or to supply power to the second sensor only while receiving the first sensor signal.

20. The liquid control system of claim 18, wherein the main control circuit is configured to control, directly or through a brew control circuit discrete from the valve control circuit, either or both of brewing a brewed liquid and heating the brewed liquid in a reservoir in fluid communication with the valve.
